(19) United States
(12) Patent Application Publication
(10) Pub. No.: US 2002/0024693 A1
(43) Pub. Date: Feb. 28, 2002

(54) Optical frequency division multiplexing

(76) Inventors: Eliezer Manor, Tal Shachar (IL); Gabriel Sirat, Rehovoth (IL); Kalman Wilner, Ramat Gan (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/841,053

(22) Filed: Apr. 25, 2001

Related U.S. Application Data
(60) Provisional application No. 60/201,314, filed on May 2, 2000.

(51) Int. Cl. H04J 14/02

(52) U.S. Cl. 359/124; 359/133

(57) ABSTRACT

A method for division multiplexing of optical signals, the method including modulating at least one wavelength of a carrier of optical information, by optical frequency division multiplexing the at least one wavelength.

### CROSS-REFERENCE TO RELATED APPLICATIONS

The present application claims priority from U.S. Provisional application Serial No. 60/201,314, filed May 2, 2000, which is incorporated herein by reference.

### FIELD OF THE INVENTION

The present invention relates generally to optical communication systems, and more particularly to frequency division multiplexing in optical communications systems.

### BACKGROUND OF THE INVENTION

An optical communication system, as used herein, refers to any system that uses optical signals to convey information across an optical waveguiding medium. Such optical systems include, but are not limited to, telecommunications systems, cable television systems, and local area networks (LANs). Many optical communication systems are configured to carry an optical channel of a single wavelength over one or more optical waveguides. To convey information from plural sources, time-division multiplexing (TDM) is frequently employed. In TDM, a particular time slot is assigned to each information source, the complete signal being constructed from the signal portion collected from each time slot. While this is a useful technique for carrying plural information sources on a single channel, its capacity is limited by electronic state of the art technology and fiber transfer properties such as dispersion, non linear effects, etc. The effects of these phenomena generally require signal regeneration subsystems along the fiber line, such as erbium doped fiber optical amplifiers (EDFAs), which are commonly used for that purpose. An alternative solution is to generate high peak power laser pulses, which limit the generated power because of the four wave mixing effect. Consequently, other techniques have been developed to increase the capacity of existing optical waveguides.

Wavelength division multiplexing (WDM), or Dense WDM (DWDM) or Coarse WDM (CWDM) are known methods for increasing the capacity of existing fiber optic networks. In general a WDM system employs plural optical signal channels, each channel being assigned a particular channel wavelength. In a WDM system, optical signal channels are generated, multiplexed to form an optical signal comprising the individual optical signal channels, transmitted over a single waveguide, and demultiplexed such that each channel wavelength is individually routed to a designated receiver. Through the use of optical amplifiers, such as doped fiber amplifiers, plural optical channels are directly amplified simultaneously, facilitating the use of various WDM configurations in long or long distance optical communication systems.

In many applications, such as optical LANs, cable television subscriber systems, and telecommunications networks, there is a need to route one or more channels of a multiplexed optical signal to different destinations. Such routing occurs when optical channels are sent to or withdrawn from an optical transmission line, e.g., for sending optical channels between a terminal and an optical bus or routing long or short distance telecommunications traffic to individual cities or customers. This form of optical routing is generally referred to as “add-drop multiplexing”.

In prior art systems, the amount of information that can be carried by one channel of a WDM fiber optics transmission line is in a bandwidth reaching the value of about 10 GHz. Considerable efforts are being made to increase the transmitted information bandwidth to 40 GHz. Transmission of a 10 GHz bandwidth, for example, may be achieved either by modulating a diode laser source directly or by using a continuous wave (CW) laser and modulating the data by means of an external electro-optical intensity modulator. However, in order to add and drop or extract part of the information from one of the WDM channels, one must first convert the entire optical signal to an electrical signal in accordance with the conventionally accepted communication protocols, and only then, extract the specific data needed. Thus, a disadvantage of the prior art is that an increase in the transmitted bandwidth requires a comparable increase in the bandwidth capabilities of the electronics components, increase the amount of reshaping signal components along the fiber lines, which in turn substantially increases the cost of the system.

Another disadvantage of the prior art is that the actual separation between two laser lines of the WDM grid is around 100 GHz, with current efforts to decrease this value to 50 GHz. Factors, such as electronic time response, jitter and drift of the laser, limit the practical bandwidth of one WDM laser to values lower than the bandwidth transmission capabilities. Thus, the wide optical bandwidth is not used to its fullest extent.

Still another disadvantage of the prior art is the fact that as the bandwidth of information transmitted is increased, problems, such as fiber dispersion, polarization dispersion as well as non-linear effects in the fiber, start to play a major factor in decreasing the distance over which the information may be transmitted.

### SUMMARY OF THE INVENTION

The present invention seeks to provide methods for multiplexing in optical communications systems, which overcome the limitations of the prior art. The present invention employs optical frequency division multiplexing in a novel way, wherein optical information is modulated by creating an additional family of optical carriers on each color (wavelength) of the WDM carriers. The system may be described as a type of “carrier on carrier” system, wherein the optical carrier (WDM) is separated (i.e., shifted) by a small additional amount with another carrier defined by a resonant electro-optical modulator frequency.

Each “family member” has an individual optical ID. The aggregate information for each WDM channel is divided into “sub-channels”, each of which operates at a relatively low bit rate of approximately 0.5-2 GHz, in accordance with individual customer or user needs, for example. The optical information emanating from each individual laser channel of the same wavelength is up-converted in the frequency domain with a different carrier frequency (separated, for example, by about 3 GHz). The up-conversion is preferably accomplished by means of resonant electro-optical modulators, in which case the frequency division multiplexing comprises resonant dense frequency division multiplexing. The up-conversion of the individual “sub-channel” may attain a resonant frequency carrier per individual WDM laser approaching 70-80 GHz, a significant improvement over the prior art. With the emerging technology of polymer materials as the crystal to be used for electro-optical modulators, frequencies as high as 120 GHz have been achieved, which will further increase the significance of the present invention.

All the optical channels are preferably inserted in one fiber transmission line, as in typical WDM system architectures. However in contrast to the prior art, in the present invention it is possible to add or drop sub-channels at any point along the line while still in the optical domain. This may be achieved by down-conversion in the frequency space, in a format or protocol compatible with the up-conversion units, and filtering the signal with a bandwidth around 0.5-2 GHz, instead of about 10 GHz or higher as in the prior art. The down-conversion may be achieved by using the same type of resonant electro-optical modulators.

In the present invention, the amount of data transmitted in one WDM channel may be increased by a factor of 2-3, while lowering the operating frequency of the associated electronics, detectors and lasers (by at least a factor of 5). The amount of data processed for each channel is much lower in comparison to the prior art, and there is no need to process the entire data in order to retrieve an individual group or sub-channel. The methods of the present invention may be implemented separately at each WDM channel.

In the WDM prior art, wherein the aggregate bandwidth, electronically multiplexed, modulates the laser directly (or by an external modulator with a CW laser), an entire channel may be shut down in the event of a catastrophic failure of the laser source or the modulator. In contrast, in the methods of the present invention, only partial information may be non-transmittable in the event of a catastrophic failure of the laser source.

In the prior art, in order to achieve high data modulation rates via laser switching, driving currents may be very high, leading to high power emission losses and a decrease in the stability of the laser. The use of external modulators at high rates also has similar disadvantages, for example, the driver is extremely bulky, sophisticated electronic control circuitry is required, power consumption is high, and the cost is extremely expensive.

In contrast, in the present invention, since the laser operates at 0.5-2 GHz, the modulation depth is much higher than laser sources operating at high bit rate. This means that for a given power, the transmission distance is much longer in the present invention than in the prior art

The present invention may increase the number of optical carriers and the overall information bandwidth per channel for many kinds of optical communication systems, such as, but not limited to, non-WDM, coarse WDM and dense WDM (DWDM) networks.

There is thus provided in accordance with a preferred embodiment of the present invention a method for division multiplexing of optical signals, the method including modulating at least one wavelength of a carrier (e.g., a WDM carrier) of optical information, by optical frequency division multiplexing the at least one wavelength.

In accordance with a preferred embodiment of the present invention the modulating includes creating at least one additional optical information carrier on the at least one wavelength of the carrier.

Further in accordance with a preferred embodiment of the present invention the modulating includes creating a plurality of sub-channels on the at least one wavelength of the carrier.

Still further in accordance with a preferred embodiment of the present invention the creating includes creating a plurality of sub-channels that carry different amounts of optical information or that have different bandwidth sizes.

Additionally in accordance with a preferred embodiment of the present invention the modulating includes controlling allocation of at least one of bandwidth size and optical information capacity to at least one user.

Further in accordance with a preferred embodiment of the present invention the modulating includes operating at a data rate of around 1 GHz, for example, or any other value that may be flexible and depend on the individual needs of a user or customer

Still further in accordance with a preferred embodiment of the present invention the method includes frequency up-converting, in the optical domain, optical information emanating from a laser channel of the carrier.

In accordance with a preferred embodiment of the present invention the optical information may be up-converted with a frequency different than a frequency of the carrier.

Further in accordance with a preferred embodiment of the present invention the optical information may be up-converted with a carrier frequency uniquely associated with an address of a receiver of the optical information.

Still further in accordance with a preferred embodiment of the present invention the up-converting may be carried out with a resonant electro-optical modulator.

In accordance with a preferred embodiment of the present invention a sub-channel may be added or subtracted to the carrier while remaining in the optical domain.

Further in accordance with a preferred embodiment of the present invention the method includes frequency down-converting, in the optical domain, the up-converted optical information.

Still further in accordance with a preferred embodiment of the present invention the down-converting includes down-converting with a resonant electro-optical modulator.

In accordance with a preferred embodiment of the present invention the plurality of sub-channels may be created by splitting a laser output of a laser by an optical splitter. The optical information may be modulated externally with all external modulator.

### BRIEF DESCRIPTION OF THE DRAWINGS

The present invention will be understood and appreciated more fully from the following detailed description taken in conjunction with the appended drawings in which:

FIG. 1 is a simplified block diagram illustration of a system and method for frequency division multiplexing of optical signals, in accordance with a preferred embodiment of the present invention;

FIG. 2 is a simplified block diagram illustration of resonant frequency division multiplexing of optical signals, in accordance with a preferred embodiment of the present invention; and

FIG. 3 is a simplified block diagram illustration of alternative embodiments of the present invention, wherein the individual laser power of one laser may be split into a number of channels by an optical splitter, and data may be modulated externally.

### DETAILED DESCRIPTION OF THE PRESENT INVENTION

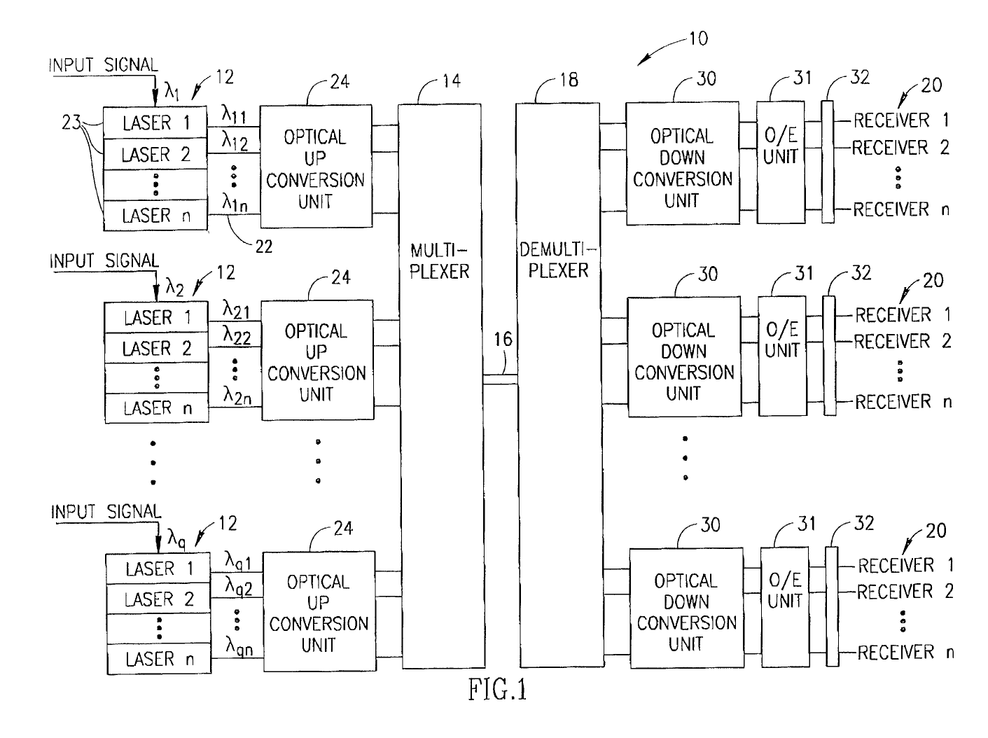

Reference is now made to FIG. 1, which illustrates an optical communication system 10 that employs frequency division multiplexing of optical signals, in accordance with a preferred embodiment of the present invention.

System 10 is preferably a WDM system that employs a plurality of laser groups 12, each of which may receive a modulated input signal. (However, it is appreciated that the invention may also be carried out for any carrier of optical information, even a single fiber.) A preferred laser is a diode laser, but the invention is not restricted to diode lasers and the skilled artisan will appreciate that the invention may be carried out with other lends of lasers as well. Each laser group 12 outputs an optical signal channel to which is assigned a particular channel wavelength λ₁ (e.g., λ₁, λ₂, . . . λₙ).

In accordance with a preferred embodiment of the present invention, at least one, and preferably all, wavelengths λ₁ (λ₁, λ₂, λₙ) are modulated by frequency division multiplexing. This is preferably accomplished by sub-dividing each laser group 12 into a plurality of sub-channels 22 (λ₁₁, λ₁₂, . . . λ₁ₘ, λ₂₁, λ₂₂, . . . λₙₘ) on the particular wavelength λ₁ of the WDM carrier, each sub-channel 22 with its own data information being created by a laser 23. Each individual sub-channel 22 is then preferably up-converted with an optical up-conversion unit 24. (It is noted that optical up-conversion unit 24 is illustrated as one block in FIG. 1, but in reality preferably up-converts each sub-channel 22 individually, as mentioned before.)

Alternatively, as seen in FIG. 3; the individual laser power of one laser 23 may be split into a number of channels by an optical splitter 17 instead of using individual lasers for each sub-channel 22. As another option, laser 23 may be a continuous wave (CW) laser and the data may be modulated externally, such as by means of an external electro-optical intensity modulator 19. The optical up-conversion methods of the invention enable transmitting sub-channels wherein each sub-channel may carry a different amount of information, and may have different bandwidth size. This capability allows flexibility of remote bandwidth control.

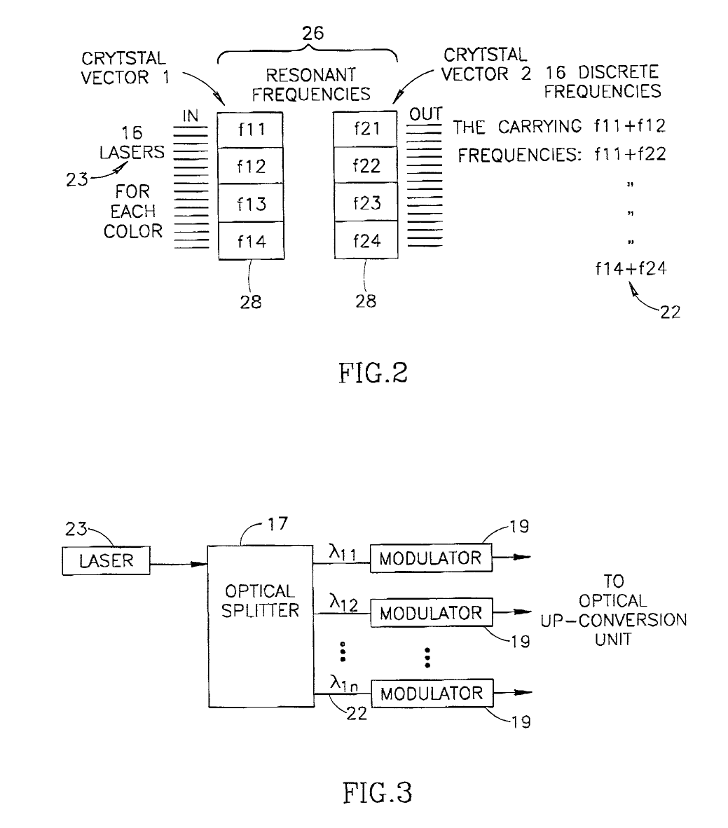

Reference is now made to FIG. 2. In accordance with one embodiment of the present invention, optical up-conversion unit 24 comprises a resonant electro-optical modulator 26. By way of example only, in the illustrated embodiment there are 16 lasers 23 for each color (wavelength λᵢ). Resonant electro-optical modulator 26 may comprise arrays of oscillating crystals 28, such as two arrays of 4 crystals with resonant frequencies f₁₁, f₁₂, f₁₃ and f₁₄, and f₂₁, f₂₂, f₂₃ and f₂₄ respectively. Resonant electro-optical modulator 26 up-converts the input wavelength λᵢ into 16 sub-channels 22 operating at frequencies f₁₁+f₂₁, f₁₁+f₂₂, f₁₁+f₂₃, f₁₁+f₂₄, f₁₂+f₂₁, . . . f₁₄+f₂₄. Another possible implementation is to arrange the crystals as a one dimensional array comprising 16 (but not limited to 16) crystals each resonating at its particular resonant frequency.

The skilled artisan will appreciate that each sub-channel 22 may be optically up-conversed in the arrangement of FIG. 3, by correcting the external data modulator 19 to an up-converter that is an electro-optical modulator operating at the resonant frequency f1 corresponding to channel λ₁₁. The second sub-channel λ₁₂ , may be connected to another electro-optical modulator operating at the resonant frequency f2 and so forth.

The term resonant electro-optic modulator, as used herein, refers to any resonant electro-optical modulator without distinction as to which stage of the up conversion system the resonant effect takes place. The resonant electro-optic modulator may be a resonant electrical source (e.g., Gunn diode or equivalent), a resonant electrical filter, a resonant wave guide cavity or a resonant optical component (e.g., Fabry-Perot, Etalon or equivalent). The term electro-optical modulator refers to a device that modulates light at a given frequency under oscillatory conditions.

In accordance with the present invention, resonant electro-optical modulator 26 may modulate the optical signals with its data content by means of a radio-frequency (RF) signal modulated by an electromagnetic field according to well-known principles of electro-optics. In accordance with one embodiment of the present invention, each sub-channel 22 operates at a relatively low central frequency, typically, but not necessarily, below 5 GHz, preferably around 1 GHz. It is noted that the invention is not limited to these values. Optical up-conversion unit 24 preferably up-converts the optical information in the frequency domain with a different carrier frequency. The different carrier frequencies may be separated from each other, for example, but not limited to, by about 2 GHz, depending on the information bandwidth. Such an up-conversion may attain carrier frequencies per individual WDM laser approaching 70-80 GHz and higher, as mentioned previously, a significant improvement over the prior art.

Reference is again made to FIG. 1. A multiplexer 14 multiplexes the optical signals channels emanating from optical up-conversion units 24 to form an optical signal comprising the individual optical signal channels, which is transmitted over a single optical waveguide 16, such as an optical fiber. A demultiplexer 18 demultiplexes the optical signal such that each channel wavelength λᵢ (λ₁, λ₂, . . . λₙ) is individually routed to a designated receiver 20.

In contrast to the prior art, in the present invention it is possible to add or drop channels at any point along the optical transmission line while still in the optical domain. This may be achieved by down-converting the optical signals with an optical down-conversion unit 30 in the frequency space, in a format or protocol compatible with optical up-conversion unit 24. Optical down-conversion unit 30 may comprise the same type of resonant electro-optical modulator as optical up-conversion unit 24. Individual outputs of the optical down-conversion unit 30 are individually routed to designated receivers 20 (receivers 1, 2, . . . n in FIG. 1). Optical to electrical (O/E) conversion may be performed at receivers 20 comprising, but not limited to, an O/E conversion unit 31, such as a photodiode, and an electrical band pass filter 32. Only the appropriate matched down conversion frequency is processed by the appropriate receiver 20.

The capacity to add and drop small channels, wherein the address of the customer is programmed at the source site by choosing a carrier frequency, opens many new avenues in routing and control of networks. This scheme may be described as “remote bandwidth control”, or a “virtual back plane” wherein a physical back plane is replaced by logical controls. For example, at a central station, management can allocate or decide how much, where and which user will get the appropriate bandwidth and capacity (e.g., offices, campuses, homes, etc. depending on the working hours and the like).

In the present invention, the amount of data transmitted in one WDM channel may be increased by a factor of 2-3, while lowering the operating frequency of the associated electronics, detectors and lasers (by at least a factor of 5-10). The amount of data processed for each channel is much lower in comparison to the prior art and there is no need to process the entire data in order to receive an individual group or channel. The methods of the present invention may be implemented separately at each WDM channel. The problems of fiber effects, including inter alia, dispersion and non-linear effects, are substantially reduced, thereby significantly increasing the attainable transmission length before any signal regeneration is required for extending the transmission length.

It will be appreciated by persons skilled in the art that the present invention is not limited by what has been particularly shown and described herein above. Rather the scope of the invention is defined by the claims that follow:

What is claimed is:

1. A method for division multiplexing of optical signals, the method comprising:
modulating at least one wavelength of a carrier of optical information, by optical frequency division multiplexing said at least one wavelength.

2. The method according to claim 1 wherein said modulating comprises modulating at least one wavelength of a wavelength division multiplexing (WDM) carrier of optical information.

3. The method according to claim 1 wherein said modulating comprises creating at least one additional optical information carrier on said at least one wavelength of said carrier.

4. The method according to claim 1 wherein said modulating comprises creating a plurality of sub-channels on said at least one wavelength of said carrier.

5. The method according to claim 4 wherein said creating comprises creating a plurality of sub-channels that carry different amounts of optical information.

6. The method according to claim 4 wherein said creating comprises creating a plurality of sub-channels that have different bandwidth sizes.

7. The method according to claim 4 wherein said modulating comprises controlling allocation of at least one of bandwidth size and optical information capacity to at least one user.

8. The method according to claim 1 wherein said modulating comprises operating at a data rate of around 1 GHz.

9. The method according to claim 1 and further comprising frequency up-converting, in an optical domain, optical information emanating from a laser channel of said carrier.

10. The method according to claim 9 wherein said up-converting comprises up-converting said optical information with a frequency different than a frequency of said carrier.

11. The method according to claim 9 wherein said up-converting comprises up-converting said optical information with a carrier frequency uniquely associated with an address of a receiver of said optical information.

12. The method according to claim 10 wherein said up-converting comprises up-converting with a resonant electro-optical modulator.

13. The method according to claim 1 and further comprising adding a sub-channel to said carrier while in an optical domain.

14. The method according to claim 1 and further comprising dropping a sub-channel to said carrier while in an optical domain.

15. The method according to claim 10 and further comprising frequency down-converting, in an optical domain, the up-converted optical information.

16. The method according to claim 15 wherein said down-converting comprises down-converting with a resonant electro-optical modulator.

17. The method according to claim 4 wherein said creating a plurality of sub-channels comprises splitting a laser output of a laser by an optical splitter.

18. The method according to claim 4 wherein said modulating comprises modulating said optical information externally with an external modulator.
